(19) United States
(12) Patent Application Publication
(10) Pub. No.: US 2009/0193034 A1
(43) Pub. Date: Jul. 30, 2009

(54) MULTI-AXIS, HIERARCHICAL BROWSER FOR ACCESSING AND VIEWING DIGITAL ASSETS

(75) Inventor: Kitt N. Hirasaki, Studio City, CA (US)

Correspondence Address: DISNEY ENTERPRISES, INC.;c/o Marsh Fischmann & Breyfogle LLP, 8055 East Tufts Avenue, Suite 450, Denver, CO, 80237, US

(73) Assignee: DISNEY ENTERPRISES, INC., Burbank, CA (US)

(21) Appl. No.: 12/018,858

(22) Filed: Jan. 24, 2008

(51) Int. Cl. G06F 17/00

(52) U.S. Cl. 707/100; 707/E17.045

(57) ABSTRACT

A digital asset browsing system allowing users to access assets in varying ways and along differing axial directions. The system includes data storage or memory devices storing digital assets (e.g., assets associated with a digital work such as an animated film). A client computing device or workstation accesses the data storage over a communications network and includes a processor, an input device for allowing a user to input data including assets queries, selections of displayed assets, and axial expansion requests, and a monitor for displaying a graphical user interface. A multi-axis hierarchical browser is run by the client device and displays in the user interface a first browser window with information corresponding to a first set of the digital assets and displays a second browser window including information corresponding to a second set of the digital assets related to the first set of assets by a user selected relationship.

### BACKGROUND OF THE INVENTION

1. Field of the Invention

The present invention relates, in general, to digital asset management methods and systems, and, more particularly, to systems and methods for organizing, searching, and accessing or viewing digital assets such as digital assets created and managed as part of producing a digital film including animated films or live action films with animation.

2. Relevant Background

An increasingly difficult task is how best to manage and access digital assets such as those created for animation, computer games, and Web site development. For example, in producing animation such as a film, the animation pipeline relies on a comprehensive database that stores files holding various versions of shots that are combined into sequences, which are in turn combined to form the show or film. Each shot may have multiple versions, and it is important for an artist or animator to be able to quickly access a particular version such as the most current version of a shot rather than an out of date version. Issues quickly become magnified as each shot includes hundreds or thousands of frames or images with a typical animated film having 24 to 30 or more frames per second, and each rendered image is composited from multiple image levels such as a background level, modeled character levels, and a foreground level. Managing or organizing such a large number of digital assets can be a logistics nightmare, and animators and others trying to access and use the assets are often frustrated by the complexity or lack of functionality of existing management programs.

Digital assets are typically defined relatively broadly to include nearly any type of digital file along with metadata describing the file (e.g., a filename, time a file was created and/or modified, and the like). Digital Asset Management (or DAM) has recently developed to provide software tools and methods for keeping an overview of digital files and making sure the files do not get lost or altered intentionally. DAM systems have been developed in an attempt to avoid situations like the following. An animation studio may start work on a computer-generated film (such as for advertising, television, or theater release) and assign numerous animation artists to the film. The artists may create assets including simple scanned sketches, constructed 3D models, textures and bitmaps, animated characters, lighting details, and the like. More and more files are stored on a server and arranged as files in folders, but problems start arising as the folder and file names become confusing to the artists. As can be seen, the typical digital content production project involves a great deal of complexity and issues that relate to the digital assets, which at the end of the project are the product (e.g., a computer game, a computer-generated movie, a web site, and the like).

The number of artists makes consistency difficult, and tension and rework quickly increase as team members too frequently overwrite a file or work on an old version of a texture or a shot. For example, more than 100 team members may work on a typical 90-minute feature film, and the film may require 130,000 or more frames or images with 30 to 50 sequences formed from 1000 to 1500 or more shots. The roles of the team members are highly specialized, which requires each team member to create and access digital assets for different reasons and with differing and sometimes conflicting goals. For example, the team may include modelers that create 3D geometry for sets, characters, and props as well as animators that make characters move and lighting artists that position and time the digital light sources. Set dressers make sure each scene looks complete, layout artists position characters and props on the set and define how the camera moves around and where it is directed, and compositors combine multiple layers of rendered images and effects to create more realistic imagery. Editors on the team splice composited shots together and fine-tune the timing of the film. The director makes sure everything fits together and that the film provides the intended experience to the viewer. Each sequence and/or shot may be assigned to a lead artist, and primary characters may also be assigned to lead artists or animators. Each of these team members may need to access different portions of the digital assets associated with a project and may want to access the assets in a way that suits their particular needs.

DAM systems are typically configured to try to organize digital assets and control access to the digital assets to avoid overwriting or loss of digital assets. However, these asset management system have not addressed the existing and growing need for producers and users of the digital assets to be able to search and access the digital assets in a variety of ways to support their roles (e.g., roles on a film production team or the like). In the team environment such as those used in creating CG films, collaboration is very important with many people using the assets. The digital assets are handed back and forth often (or checked in and out of the central data store). Issues with digital assets also arise in situations such as digital film production where all working versions are saved in case a decision is made to go back to an earlier version or to allow recycling of an unused version on the same or other projects. Saving many versions of the same modeled object or character can cause problems with accessing the correct versions of an image (such as of a composite level) as well as of insuring that the most current version is used. Some DAM systems track version histories to allow users to compare different versions of a digital asset; however, it may not be easy for the user to relate the image being reviewed to other portions of the work in progress (e.g., to other team members' efforts or other created assets). Some DAM systems allow users to view thumbnails of files in the central repository, such as in a visual client, even in the case of varying file types or formats, but it is typically difficult to easily search the assets. For example, a manual grouping of files into folders may not facilitate the type of searching needed by all team members or the organization may not suit all when there are many asset users.

Hence, there remains a need for improved methods and systems of organizing and accessing digital assets. Preferably, such methods and systems would be configured to support asset production projects such as digital film creation including animation used in animated films and live action films.

### SUMMARY OF THE INVENTION

The present invention addresses the above problems by providing methods and systems for accessing and browsing digital assets such as those associated with production of an animated film/digital movie. The browsers or browser programs are used to provide graphical user interfaces that allow a user such as an animator, editor, or the like to access the digital assets at any of a number of hierarchical levels and, then, to expand on or drill down into the digital assets from this level in any of a number of directions (e.g., along any of a number of hierarchical axes). In this manner, the user is not limited to a simple hierarchy with a single parent-child progression but instead may redirect the investigation as suits their needs. This may be achieved in part by storing the digital assets with hierarchical tags that provide such axial relationship data. In another aspect, the user can enter search terms such that the next expansion or investigative level involves the browser identifying a subset of the digital assets that have a matching searchable parameters, which may be provided as a portion of metadata associated with the digital assets. Each expansion level may be presented to the user in the graphical user interface by altering the current display or via additional browser windows or subwindows (e.g., a horizontally opening browser, a vertically opening browser, split windows, or the like).

More particularly, a digital asset browsing system is provided that includes data storage or memory devices that store a plurality of digital assets (e.g., assets associated with a digital work such as a movie or animated film). The system includes a client computing device or workstation that accesses the data storage over a communications network such as the Internet, a LAN, a WAN, or the like. The computing device includes a processor, an input device for allowing a user to input data including assets queries, selections of displayed assets, and axial expansion requests, and a monitor for displaying a graphical user interface. A multi-axis hierarchical browser is run by the client computing device. The browser processes user input provided via the input device and, in response, displays in the graphical user interface a first browser window comprising information corresponding to a first set of the digital assets (e.g., accesses and retrieves a set of information or assets from the data storage based on user input). The browser further displays a second browser window including information corresponding to a second set of the digital assets that are related to the first set of assets by a user selected relationship. In some cases, the user selected relationship may be selected from a set of two or more predefined hierarchical relationships displayed to the user via the interface (e.g., a time-based relationship or one of a number of parent-child type relationships such as versions of a particular composite level or shots for a particular sequence in an animated film or the like). The processing by the browser may include comparing the user selected relationship to data in a digital assets management tag that is associated with each of the plurality of data assets in the data storage. The user selected relationship may include search terms provided in a query and the processing by the browser may include searching metadata tags for the assets for parameters that match one or more of the search terms to return the second set of digital assets from the data storage.

The browsing system may be particularly well suited for use with video production, and, in this regard, the plurality of digital assets may be digital assets associated with a digital movie (here considered equivalent to any work including digital video such as an animated film or a live action film with digital or animated portions). The first set of the digital assets may be one of: sequences for the digital movie, shots for one or more of the sequences (or character/element test shots), rendered images for one or more of the shots, composite layers for one or more of the rendered images, and versions of one or more of the composite layers. The second set of the digital assets is then a differing one of these layers of assets.

### BRIEF DESCRIPTION OF THE DRAWINGS

FIG. 1 is a functional block diagram of a digital asset management system of one embodiment of the invention showing use of multi-axis hierarchical browsers running on clients or workstations to search and access/view digital assets such as those associated with producing a digital movie or an animated film;

FIG. 2 illustrates a hierarchical organization of digital assets associated with a digital movie showing some potential hierarchical relationships among the assets;

FIG. 3 illustrates a screen shot of an exemplary user interface that may be provided by a browser of the invention to display information from a digital asset data store;

FIG. 4 illustrates a screen shot of another exemplary user interface provided by a browser of the invention to display information from a digital asset data store, with a differing axial relationship relative to the display order shown in FIG. 3;

FIG. 5 illustrates a screen shot of a user interface provided by a browser of the invention displaying digital asset data with a version viewer in thumbnail mode along with an editor window; and

FIG. 6 is a flow chart of a method of digital asset browsing according to one embodiment, such as may be implemented with the system of FIG. 1.

### DETAILED DESCRIPTION OF THE PREFERRED EMBODIMENTS

Briefly, embodiments of the present invention are directed to methods and systems for allowing a user, such as an animator or others working with digital assets, to investigate or to search and access digital assets in a data store along a plurality of axes rather than simply along a single, predefined hierarchical axis (e.g., file/folder structure formed on a set of rules for asset groupings). Embodiments of the invention provide such functionality with multi-axis hierarchical browsers running on clients or workstations in a digital asset management system. The digital assets are created and stored with relationship data (e.g., metadata), and the browsers provide user interfaces or screens that allow the user to search based along a number of axes or dimensions such as based on relationship data (e.g., shots of a particular character having a particular attribute or other tag data or tag-based search) rather than merely on hierarchy data (parent/child data). For example, tag parameters may be associated with at least some of the digital assets in a data store and a user could perform a first query to obtain a subset of the assets and then drill down or investigate the subset further along one or more axes or directions (e.g., in an animation project, a request may be made to view simulation shots such as cape shots for a superhero and then this subset may be investigated based upon a specific parameter such as stiffness of the cape used in the simulation, and this information may be included in the tag (e.g., relationship data and/or asset tag data or metadata). A user is able, in some cases, to apply a different filter or query at each accessing or processing step to in effect move along a different axis rather than simply following a predefined hierarchical or tree path. The browsers and digital asset management systems of the invention are particularly well suited for use with video data and film productions but are also useful with still image data and other digital assets.

The following description provides examples of particular multi-axis hierarchical browsers, user interfaces or screens provided by running such browsers, and configurations of useful data stores and digital assets (e.g., with particular tags and metadata). However, it will be understood that these are only representative examples of useful implementations of the invention and not as limitations to its breadth. Further, embodiments of the invention may be thought of generally as a computer-based method for storing and accessing digital assets, and the particular software, firmware, and/or hardware used to implement this method are also not limiting of the invention. In general, the algorithms, routines, and processes described herein may be implemented upon nearly any computer-readable medium that can cause a computer or computer system to perform a corresponding function. For example, the multi-axis browser or browser program may be provided as software or programming code for viewing files and assets and be stored on a memory device of a client node, computer, or workstation that uses one or more processors or CPUs to run the software. The workstation likely will include a number of input/output devices (I/O devices) such as a keyboard, a mouse or trackball or the like, a touchscreen or pad, a voice recognition mechanism, and the like. A monitor or monitors will also be provided to allow the user to view the user interface and to view accessed digital assets, and video and audio playing equipment may also be provided as part of the workstation. The user interfaces may be nearly any combination of menus, screen designs, keyboard commands, command language, and the like (including in some cases mice, touch screens, and other input hardware such as voice recognition) to allow a user to interact with a computer and, in this, with digital assets stored in memory. The invention may also be implemented using one or more data servers that may communicate with the workstations over a digital communications network such as the Internet, a local area network, a wide area network, or the like using any of a number of well-known or later developed communications protocols (wired or wireless), and the browsers and related applications may be provided as web applications. The digital assets may also be stored using any of a number of file formats, and the particular format is not limiting to this description or the appended claims.

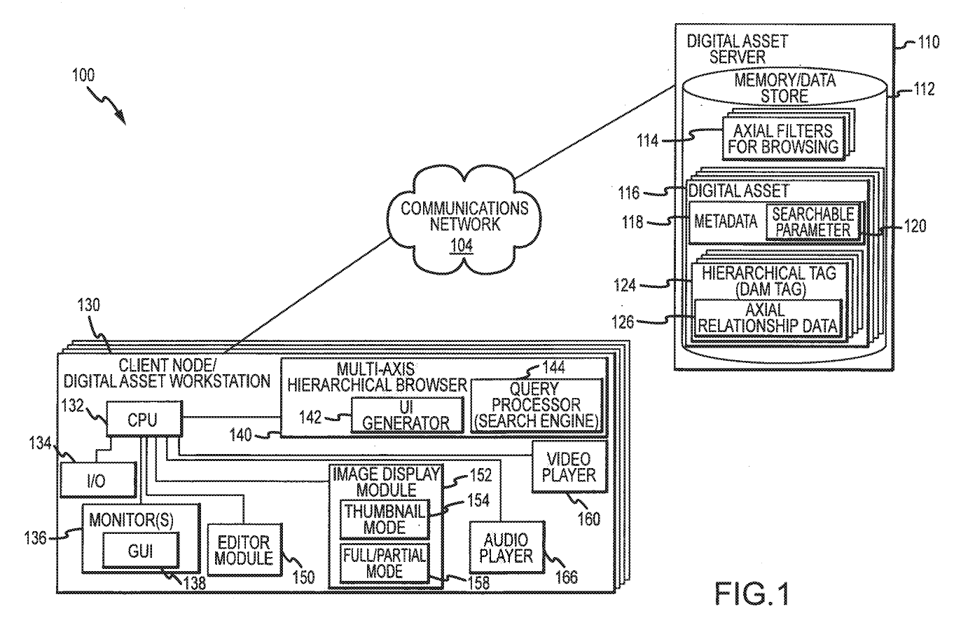

FIG. 1 illustrates a functional block diagram of digital asset management system 100 of one embodiment showing use of a multi-axis hierarchical browsers running on clients or workstations to search and view/access digital assets such as those associated with producing a digital movie or an animated film. As shown, the system 100 includes a digital asset server 110 that is accessed over a communications network 104 by one or more client nodes or digital asset workstations 130. The digital asset server 110 includes memory or a data store 112 that stores digital assets 116 that may be accessed, in part, by applying axial filters 114 (default filters and/or filters selected by an operator or user of the workstation 130). In the data store 112, a plurality of digital assets 116 are stored, and “assets” in this context is intended to refer to nearly any digital data file. In some embodiments, the assets may be digital information that can be combined to create a digital film or animated work such as versions of a composite layer or image, images rendered using such composite layers, texture definitions, rigging details, modeling components and information, shots or shot definitions, sequences or sequence definitions, and the like.

For at least some of the digital assets 116, metadata 118 may be included and associated with the asset. The metadata 118 may take any useful form and may include searchable parameters 120. For example, metadata 118 may include information 120 that is searchable such as a title of the asset that is searchable (such as a character's name, an object's name, or the like), a time the asset was created/modified/saved that is searchable (e.g., a query may request objects or assets stored after a particular time), a characteristic or parameter that is searchable (e.g., a query may ask for rendered images generated using a particular technique such as a motion capture technique or that have a setting such as a texture, a stiffness, and the like).

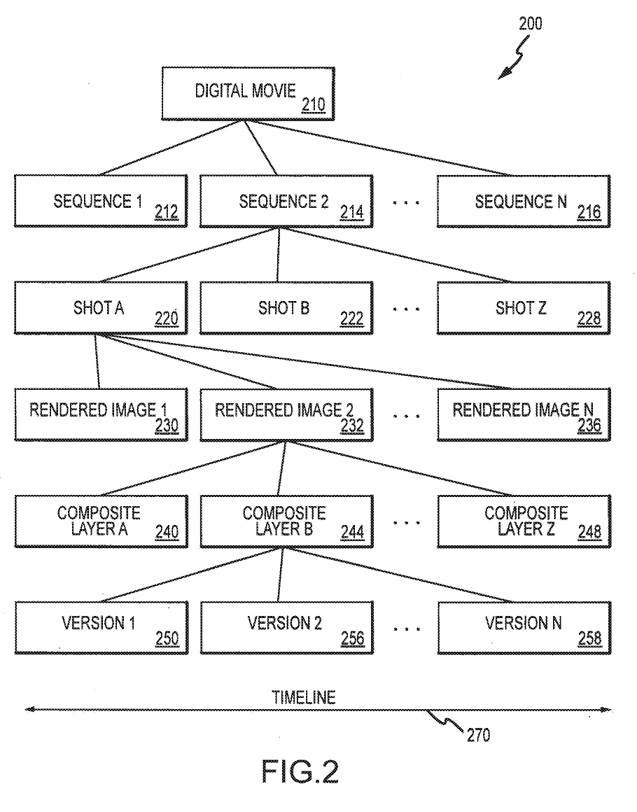

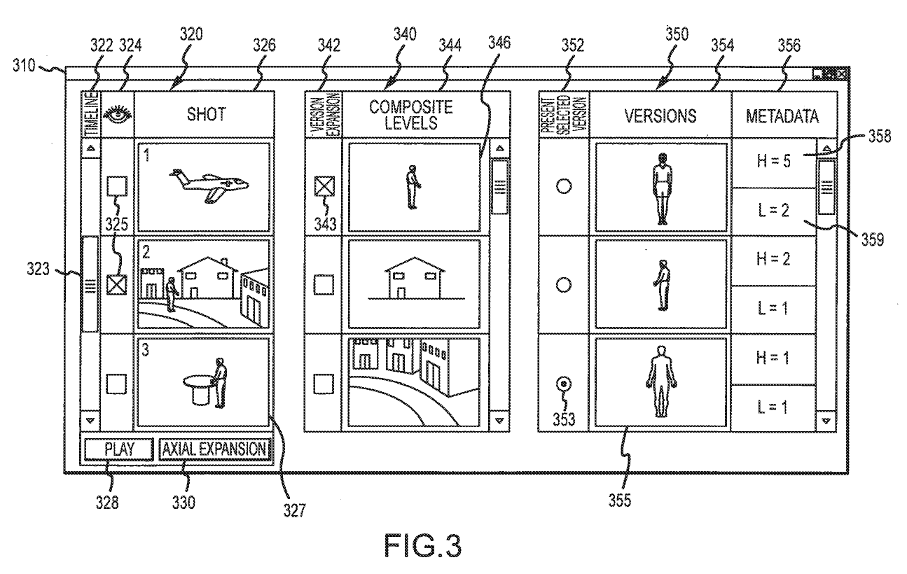

In addition to searchable parameters 120, the digital assets 116 are tagged with a hierarchical tag (or DAM tag) 124 that allows a user to access the assets 116 along varying axes rather than a single parent-child route. The relationship among the assets 116 (or one asset to one or more of the other assets) is shown as defined in part with axial relationship data 126 provided as part of the DAM tag 124 for each asset 116. As will become clear (e.g., from discussion of FIG. 2 and the interfaces of FIGS. 3-5, the axial relationship data 126, in combination in some cases with the searchable parameters 120, is useful for applying a unique filter at each processing or browsing step to investigate or drill down into a database or store of assets such as that provided by data store 112.

The workstation (or client device/node) 130 is communicatively linked to the network 104 to communicate with the digital asset server 110. For example, the workstation 130 may be a desktop, laptop, or other computing or electronic device adapted for processing digital information and transmitting messages in electronic form over the wired and/or wireless network 104 such as queries to the server 110 to locate and retrieve one or more of the assets 116 that are then served to the client node 130. To this end, the workstation 130 is shown to include a CPU 132 that operates I/O devices 134, memory (not shown), and one or more monitors 136 that are used to display/provide a graphical user interface 138. The CPU 132 also operates or runs a multi-axis hierarchical browser 140, an editor module 150, and an image display module 152, and it may also operator or communicate with a video player 160 and an audio player 166.

The browser 140 may be provided as software, firmware, and/or hardware 140 to provide the asset management functions. These functions may include providing a UI generator 142 that creates and runs the GUI 138 and a query processor (or search engine) 144 that processes user input to provide an investigation or browsing tool for accessing the digital asset server 110. The workstation 130 may allow the browser 140 to provide editing functions in the GUI 138 or otherwise, and this may be achieved by calling or using editor module 150 such as to view and manipulate or edit digital assets 116 served by server 110 in response to queries by a user of the workstation 130 (e.g., entering search parameters to compare to parameters 120 in metadata 118). Also, during use of the browser 140 the GUI 138 may be adapted to display images retrieved from the store 112, and the browser 140 may be configured to provide this functionality or it may call an image display module 152. The module 152 (or the browser 140) may be adapted to display on the monitor 136 in GUI 138 or separately, the retrieved/accessed images 116 as thumbnails with a thumbnail mode 154 of the module 152 or in a full or partial image with mode 158. The user interface 138 may allow a user to play (e.g., by selecting a play button or the like) one or more of the digital assets 116, and to this end, the browser program 140 or CPU 132 may call or use a video player 160 and/or an audio player 166, which may be programs/code that play the assets 116 on the monitor 136 and/or with separate components (such as a separate video display device and separate audio output devices).

FIG. 2 illustrates an exemplary arrangement 200 of digital assets such as assets 116, which is useful for illustrating how DAM tags 124 and axial relationship data 126 may be used by an operator of the browser 140 to access the assets 116. Generally, a browser 240 may function when run by a CPU 132 to create a GUI 138 that allows a user to enter search terms or queries, and this information may be processed by search engine 144 to determine which assets 116 match the tag data 124 such as axial relationship data 126 (or, in other cases, the searchable parameters 120 of the metadata 118). The example 200 is for managing and accessing assets associated with production of a digital movie, and first search query may be entered via a GUI 138 for all assets 116 related to a particular movie 210.

This subset of digital assets 116 may then be further processed in a number of ways or along a variety of axes or dimensions according to embodiments of the invention rather than a single hierarchy imposed upon the data. As shown, a user has queried the digital movie 210 set of assets for all sequences of the movie 212, 214, and 216, and these may be located based upon axial relationship data 126 (or, in some cases, based upon searchable parameters 120). Typically, the retrieved assets such as sequences 212, 214, 216 are arranged according to a timeline 270, e.g., as the assets are used in a movie 210, when assets were created and/or stored, or the like, but other arrangements may be used for presenting the results of a query. A user may further operate the browser 140 to drill down further by adding another filter, e.g., shots for the second sequence 214 as shown with shots 220, 222, 228. Another filter may be applied to view all rendered images 230, 232, 236 in timeline manner 270 for a particular shot 220. Again, this subset of images 230, 232, 236 may be located using the DAM tag 124 information as shown with axial relationship data 126. An additional filter may be applied via the browser 140 to access the composite layers 240, 244, 248 for one of the rendered images 232 by providing a search term in a query processed by search engine 144 on assets 116. Further, as shown, the composite layer 244 may further be investigated by requesting all versions 250, 256, 258 associated with the layer 244.

The searching or accessing of the digital assets 116 shown in graph 200 may appear to be merely hierarchical, but it should be understood that the user of the browser 140 may control how and when filters are applied and on what level the data access occurs. In other words, the user can readily access the data 116 in a different order or along differing axes than shown in FIG. 2. For example, a user may apply a filter that skips the sequence layer (elements 212, 214, 216) by requesting all shots for the movie 210 which would include the shots 220, 22, 228 plus shots for sequences 212, 214, and 216. Alternatively, the user may apply a filter that applies axial relationship data 126 along with a searchable parameter 120 such as all rendered images that include a particular character (such as by character name or the like) or that have a particular simulation (such as a simulation of a cape). In these ways, the user controls by operation of the browser 140 along which organizational axis the digital asset is accessed, and then later investigation may be based upon axial relationship data 126 and/or searchable parameters. For example, a user may obtain access directly to the rendered images 230, 232, 236 and then uses hierarchy data as shown in FIG. 2 to view composite layers 240, 244, 248 and then versions 250, 256, 258. The flexibility of the multi-axis hierarchical browser 140 is further demonstrated with the following examples of user interfaces and their use to access various digital assets.

FIG. 3 illustrates a screen shot of an exemplary user interface 310 that may be generated by a browser, such as browser 140 of FIG. 1, to display information from a digital asset store (such, as store 112) in response to user queries and input. As shown, the interface or window 310 includes a first window 320 that may displayed in response to a user entering an initial search query or filter for all shots for a movie or a particular sequence (or that meet some other criteria such as a hierarchical relationship or a parameter that is searchable). The first browser window 320 includes a timeline column or indicator 322 with a slide bar or indicator 323 for moving along a timeline through the shots 326 to an active view (e.g., the retrieved and displayed shots 326 may be too large in number to show in the window 320 and it may be useful to move through the shots 326 in a time-related manner (i.e., the shots are arranged along a timeline according to their position in a digital movie or the like)). The window 320 also includes a display or viewing selection column 324 in which a user may choose (such as with a mouse click or the like) a box 325 as shown for shot “2”. The user may then select a play button 328 to have the selected shot played, such as via a video player 160 as shown in FIG. 1. The accessed/retrieved shots 326 are shown with thumbnails 327 in this embodiment.

A user may select one or more of the shots 326 based on their thumbnails or other descriptive information (e.g., the window 320 may also include metadata, DAM tag, or other information for the shots 326) and select button 330 to perform an axial expansion of those shots. For example, selection of the button 330 may result in a default expansion (e.g., an expansion of retrieving and displaying of all rendered images for the selected shots as shown in FIG. 2) or a drop down list or query box may be presented to the user to display axial filters for browsing (such as filters 114). The user can then select one or more of these filters 114 for application to the particular shot (i.e., to the digital assets 116 associated with the chosen asset or shot). For example, the user may choose to expand upon a composite level axis, and this is shown in FIG. 3 by the interface 310 being updated by the browser 140 to display the second browser window 340. The second browser window 340 includes an expansion column 342 to request further expansion and a column 344 for displaying (by thumbnail or the like) composite levels for the selected shot. The version expansion column 343 allows a user to select (i.e., by selecting a box 343) one of the composites shown by thumbnail 346 for flyer expansion by version. In other embodiments, the expansion of a composite level 344 could be along a differing axis or based upon a searchable parameter.

As shown, the selection of a version expansion box 343 causes the browser 140 to update the user interface 310 to display a third browser window 350. As can be seen from the three windows 320, 340, and 350, the user interface 310 is configured as a horizontally opening browser but other configurations may be used (e.g., ones where previous windows are closed as the next window or filtered layer is opened). The window 350 has a column 352 indicating the present selected version at 353 that is being used in the composite 346. The window 350 also has a versions column 354 showing the current and prior, saved versions with thumbnails 355. The saving of prior versions as digital assets 116 is common in the production of animated films and digital movies, and it is useful for the browser 140 to function to include an expansion (e.g., an axial expansion) that relates not only the current version but prior versions to a particular composite level (or, in some cases, to a particular rendered image or other digital asset such as a texture file or the like). A metadata column 356 displays data or searchable parameters 358 and 359 (e.g., head size or shape parameters and leg parameters or length in this example). Such metadata may be associated with any of the digital assets (e.g., with the composite levels and shots), and, hence, a search or filter application may include a user providing search parameters or query terms that the browser 140 (or its search engine 144) may use to access the data store to retrieve particular subsets of the digital assets.

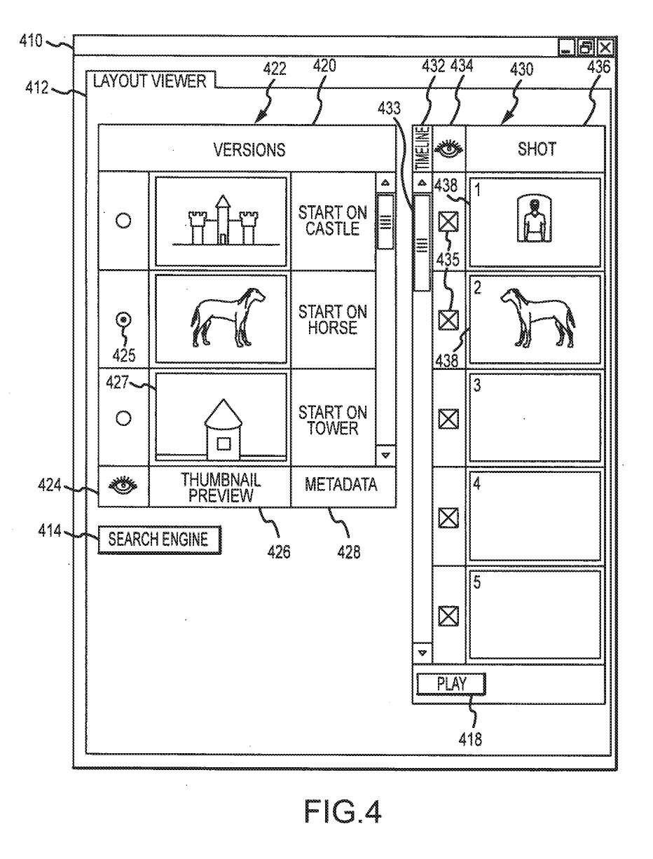

FIG. 4 illustrates a screen shot of another exemplary user interface 410 with a layout viewer or layout window 412 as may be generated by browser 140 of the system 100 of FIG. 1. As shown, the user interface 410 includes a first window 422 that shows the digital assets or versions matching a previously entered filter or query term(s). For example, a user may use the layout viewer 412 or access digital assets via a different path or axial relationship. In the example shown, a user working on a digital project may prefer to access in the window 422, and then by default or by request have the shots displayed below or in a lower hierarchical level. The first window 422 is configured to allow a user to select the version to expand such as with a button, box, or the like 425. These may also be viewed or played as shown by indicator 424 by selecting a play button 418 (e.g., via a video player) The window 422 includes thumbnail previews 426 of the various versions of the work selected by the user and also includes a metadata column 428 that displays at least a portion of the metadata (or searchable parameters) for that version (or other digital asset). A search engine or query button 414 may be used by the operator to enter one or more search terms to perform a tag or metadata search (e.g., particular shots for the selected version or for all versions that meet particular criteria or other digital assets related to the versions that have searchable parameters associated with them). In other cases, the search engine 414 may allow a user to search for digital assets meeting other criteria (egg., to change the interface 4110 to display a new viewer 412 or new window 422).

The second or shot window 430 may be displayed by default for the versions, based on the positioning of the indicator bar, or, as shown, based on selection at 425 of a particular version (e.g., by its thumbnail representation). The shot window 430 includes a timeline column 432 with an indicator or slide bar 433 indicating an active shot (e.g., for playing by selection of the button 418 or for viewing more shots 436 as a user scrolls along the timeline through the shots 436 in a particular version 420. The shot window 430 further includes a selection or view column 434 in which a user may select such as with boxes 435 shots 436 for use a play mode or for expansion of the shots by another layer of assets or information (not shown in FIG. 4). The shot column 436 is provided in the window 430 to provide previews via thumbnails 438 of the various shots associated with a particular version (e.g., a version of a film or a version of a sequence of a film or the like). Again, the browser window or interface 410 may be adapted to allow the user to select a shot (such as with keystrokes or by another selection technique such as a mouse) for play 418 or for further expansion (e.g., display all rendered images composites or other assets associated with the shot). The user interface or browser window 410 is useful for illustrating that browsers of the invention allow a user more than one dimension or axis for investigating assets in a data store as differing hierarchical layers may be provided on top or as an initial result (e.g., by applying a differing initial filter) and the next layer or filter applied can provide a user-specified drill-down direction (e.g., not necessarily simply a continuation of a predefined hierarchy).

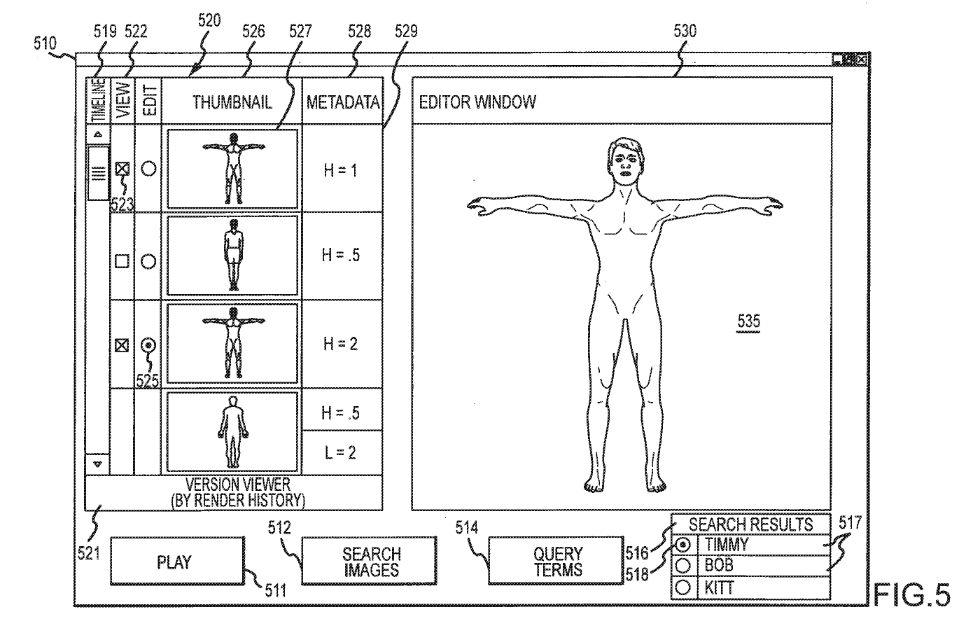

FIG. 5 illustrates a screen shot of another user interface or window 510 that may be generated by a browser program of the invention. In this example, the browser program operates to present the user (e.g., on the monitor of their workstation or other device) a first window 520 that provides a viewer 421 for viewing versions of a rendered object arranged or ordered by rendering time or history. As shown, the window 420 includes a timeline column 519 with a slider for selecting images for viewing in the window (e.g., active images). In this context, “timeline” may indicate the time at which the images were rendered but in other cases “timeline” may be their frame order in a movie. Hence, the slider may instead be provided in “Creation Time” or similar column. A view column 522 is provided that allows a user to select via boxes 523 or similar components one or more images provided in image column 526 where thumbnails 527 are provided of the images for allowing a user to preview the images. The images selected in column 522 may then be played by selecting the play button 511. A user may choose to edit as shown at 525 one of the images shown in column 526.

A second browser window or editor window 530 is provided for displaying a user interface for an editor (such as editor module 150 shown in FIG. 1). The displayed image 535 may be edited to update or modify the selected image, i.e., to modify the digital asset which then may be saved in the data store. In this manner, browsers of the invention may be used along with editing and other animation or production tools to manipulate or work with digital assets (e.g., the browser tool is not limited to simply accessing assets but can be used in conjunction with many know animation tools to produce digital assets).

The first browser window 520 may be configured to display metadata or hierarchical or DAM tag information. As shown, the column 528 is used to display metadata or searchable parameters 529 for each of the retrieved or served images 527. The metadata 529 may be used to search the images and/or to order the images after retrieval in the window 520 (e.g., in order based on parameter values rather than on the timeline or render history 519). A search images button 512 may be used by the operator of the interface 510 to search for a new set of images or digital assets. For example, the images 527 may be provided as the result of a query with search or query terms being entered in box or other data entry component 514 (e.g., characters having the “H” parameter less than “3” or the like). Search results may provided in box or subwindow 516. The user may then select via button 518 one of the results with the result identified by metadata and/or axial relationship data 517. As shown, the character named “Timmy” has been selected by the user, and versions of rendered images 527 for this selected character are shown in the first browser window 520 based on their render history. Based on a review of the three interfaces of FIGS. 3-5, it is clear that the browsers function to provide a multi-axis access and display tool (with the axes of time, composite, and version being shown by the non-limiting examples).

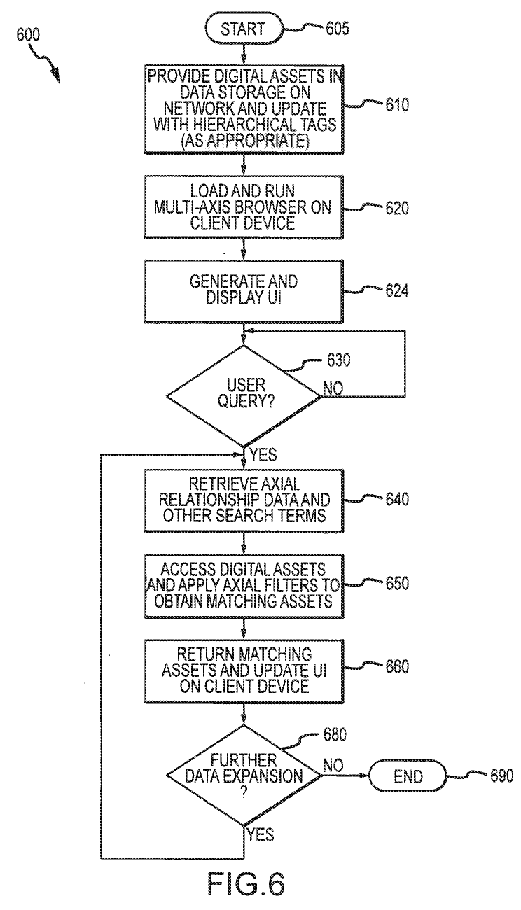

FIG. 6 illustrates method 600 of browsing digital assets (e.g., as may be implemented by operation of the computer system 100 shown in FIG. 1 or by using program code devices or routines stored on computer readable media to cause a computer to perform the steps/functions shown). The method 600 begins at 605 such as by providing a digital asset server for storing digital assets and making such a server accessible by one or more clients over a wired or wireless digital communications network(s). The method 600 continues at 610 with storing digital assets in a data store accessible by client devices and associating searchable metadata with most if not all of the assets and, in some cases, providing DAM tags providing axial relationship and/or hierarchical data for the assets. At 620, a multi-axis browser may be loaded upon client devices or this may be served or loaded for use on the devices prior to use.

At 624, the browser may function to generate and display a user interface on the client device monitor, e.g., to display one of the interfaces shown in FIGS. 3-5 or another interface configured to facilitate browsing as described herein. At 630, the computer checks to see if the user has entered a query such as by selecting a portion of the digital assets and entering search terms (e.g., hierarchical relationship data, key words or search terms for comparison to searchable parameters associated with the assets, and the like such as selecting a digital movie or work project and providing search terms useful for selecting a level of a hierarchical relationship in the digital assets). If not, the method 600 loops back to step 630.

If a search is entered or a browsing request is made, at 640, the method 600 continues with retrieving axial relationship data (if provided) and other search terms (if provided). Obese search terms may include predefined axial filters for browsing (as shown at 114 in FIG. 1) and other search terms, and these search terms and/or axial filters are applied at 650 to access the digital assets and obtain matches to the search. At 660, the method 600 continues with returning a set of matching digital assets to the client device and operating the browser to update the displayed user interface such as by updating a window in the interface to display representative images or thumbnails of the images along, in some cases, with metadata/hierarchical relationship data as appropriate for the particular asset. At 680, the method 600 continues with determining whether the user is requesting further data expansion. If not, tile method 600 ends at 690, and if so, the method 600 continues at 640 with obtaining the next search terms or expansion direction (e.g., if the first hierarchical level retrieved and displayed is shots the next expansion request may be for composite levels).

Numerous embodiments of browsers and their associated user interfaces and variations of those shown will be apparent to those skilled in the art once the above description is understood, and these variations and expansions of the teachings are believed within the scope of the invention and appended claims. For example, the browsers may be configured as full hierarchy opening or drill-down browsers such as by providing one in which new windows or displays are opened upon each expansion or by changing the screen with each expansion. The functions of the browser and associated user interfaces provide alternate browsing direction commands that can be used by the operator or user of the browser to investigate the digital assets along differing axes, e.g., by applying differing filters at each step (rather than a predefined, single next expansion). The step down to a next level of detail or a next hierarchy level can be done in different ways and the invention is not limited to a particular approach.

The user interfaces, such as those shown in FIGS. 3-5, are typically designed to indicate which is the active digital asset (or parent) that is active and associated with other digital assets having their data shown in other portions of the window or in subwindows (e.g., child of the parent). This may be done by presenting horizontally opening windows as shown (or vertically opening windows with the next window presented below the parent) with a selection button or box indicating the active digital asset (or parent). Other techniques may be used to visually distinguish which is the active asset such as by using colors, labels, icons, lead lines or arrows, or the like to link the chosen or active asset with the corresponding expansion window or subset of digital assets (or data associated with such child assets or assets having particular searchable parameters).

The user interface may present interrelated digital assets to indicate their relationships. For example, a timeline may be one axis used to investigate digital assets associated with a digital asset such as a digital movie or animated film or clip. An editorial view user interface may present digital assets such as video assets based on a user's search terms as described with reference to FIGS. 2-6, and the user interface may provide along a common timeline (such as above or below in the same or adjacent windows) audio digital assets such as background music, dialog of the digitized or animated characters, and the like. The editor viewer may allow the user or operator to select (such as by double clicking with a mouse or the like) particular assets along the timeline for further investigation (such as differing composite layers or versions of a video asset, differing takes or versions of the dialog, differing background music, and the like). In this manner, such an editor view may allow a user to handle audio clips in conjunction with audio or other related assets or independently of such other assets (or vice versa as it may be useful to investigate audio assets independent of the video assets).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. The browser allows a user to access stored digital assets in a variety of directions, at differing starting points or levels, and along a number of differing hierarchical axes. For example, a user may request for a digital movie or animated film a set of assets associated with a particular sequence and then ask for all versions of the sequence (e.g., various cuts which may be presented by creation or storage date). The user may select one of the prior sequence versions or cuts to investigate rather than simply the current version. Then, the user may request all shots for the sequence chosen and so on. The user can choose the starting point or level and then choose a simple parent-child direction, alter such simple path by moving along a timeline (e.g., to an earlier stored asset or version), or move in a new direction such as with a tag search for assets with particular metadata parameters (e.g., shots having a particular texture, a particular character, or the like such as “Find All Shots of Timmy with a Cape” and order by cape stiffness or another parameter).

I claim:

1. A digital asset browsing system, comprising:
data storage storing a plurality of digital assets;
a client computing device accessing the data storage over a communications network, the client computing device comprising an input device and a monitor for displaying a graphical user interface;
a multi-axis hierarchical browser run by the client computing device, wherein the browser processes user input via the input device and, in response to the processing, displays in the graphical user interface a first browser window comprising information corresponding to a first set of the digital assets and a second browser window comprising information corresponding to a second set of the digital assets, the second set of the digital assets being related to the first set of the digital assets by a user selected relationship.

2. The system of claim 1, wherein the user selected relationship is a hierarchical relationship selected from a set of two or more predefined hierarchical relationships.

3. The system of claim 2, wherein the selected hierarchical relationship is time based.

4. The system of claim 1, wherein the processing by the browser comprises comparing the user selected relationship to data in a digital assets management tag associated with each of the plurality of digital assets.

5. The system of claim 1, wherein the plurality of digital assets are digital assets associated with a digital movie and the first set of the digital assets comprises one of sequences for the digital movie, shots for one or more of the sequences, rendered images for one or more of the shots, composite layers for one or more of the rendered images, and versions of one or more of the composite layers and the second set of the digital assets comprises a differing one of the sequences for the digital movie, the shots for one or more of the sequences, the rendered images for one or more of the shots, the composite layers for one or more of the rendered images, and the versions of one or more of the composite layers.

6. The system of claim 1, wherein the user selected relationship comprises search terms provided in a query and the processing by the browser comprises searching metadata tags for the plurality of assets for searchable parameters matching one or more of the search terms to return the second set of the digital assets.

7. The system of claim 1, wherein the first set of digital assets comprise video assets and the system further comprises a video player playing a user selected one of the video assets in response to a user command provided via the graphical user interface.

8. The system of claim 1, the browser further processing additional user input provided via the input device indicating a selection of one of the assets in the second set of the digital assets and a hierarchical relationship from two or more relationship definitions, and, in response to the processing, displaying a third browser window comprising information corresponding to a third set of the digital assets, the third set of the digital assets having a hierarchical relationship to the selected one of the assets.

9. A computer readable medium for browsing digital assets stored in memory, comprising:
computer readable program code devices configured to cause a computer to effect displaying a graphical user interface on a display device;
computer readable program code devices configured to cause the computer to effect processing first user input to select a first set of the digital assets and to update the graphical user interface with data corresponding to the first set;
computer readable program code devices configured to cause the computer to effect processing second user input to select an asset in the first set and to request expansion of the selected asset in one of two or more axial directions;
computer readable program code devices configured to cause the computer to effect accessing the digital assets to identify a second set of the digital assets based on the selected asset and the one of the two or more axial directions; and
computer readable program code devices configured to cause the computer to effect the computer to update the graphical user interface to display data associated with the second set of the digital assets.

10. The computer readable medium of claim 9, wherein the first set of the digital assets is a set of hierarchically related data selected from a plurality of hierarchical levels.

11. The computer readable medium of claim 9, wherein the digital assets are associated with an animated film and wherein the hierarchical levels comprise sequences, shots, rendered images, composite layers, and versions of composite layers.

12. The computer readable medium of claim 11, wherein the selected asset is one of the shots and the second set of the digital assets comprises rendered images for the one shot.

13. The computer readable medium of claim 11, wherein the selected asset is one of the composite layers and the second set of the digital assets comprises versions of the one composite layer.

14. The computer readable medium of claim 9, further comprising:
computer readable program code devices configured to cause the computer to effect processing third user input providing search terms and accessing the digital assets to locate matching ones of the digital assets based on a comparison of the search terms with metadata associated with at least a portion of the digital assets; and
computer readable program code devices configured to cause the computer to effect displaying data associated with the matching ones of the digital assets in the graphical user interface.

15. A computer-based method for accessing digital assets stored in memory, comprising:
with a computer, displaying a user interface on a monitor;
from an I/O device, receiving first user input;
with the computer, accessing the digital assets to identify a first set of the digital assets based on the first user input and modifying the user interface on the monitor to display data corresponding to the first set of the digital assets;
from the I/O device, receiving second user input selecting one of the assets in the first set and third user input requesting an expansion of the selected one of the assets, the expansion being one of a plurality of axial expansions displayed to the user via the user interface; and
with the computer, accessing the digital assets to identify a second set of the digital assets based on the selected one of the assets and the requested expansion and modifying the user interface on the monitor to display data corresponding to the second set of the digital assets.

16. The method of claim 15, wherein the requested expansion is for all versions of the selected one of the assets stored in the memory.

17. The method of claim 15, wherein the requested expansion is for a set of data having a hierarchical relationship to the selected one of the assets, the hierarchical relationship being one of a set of two or more hierarchical relationships.

18. The method of claim 15, wherein after the second modifying, the user interface comprises at least a first and a second window displaying the data corresponding to the first and second sets of the digital assets, respectively, and wherein the first window comprises an indicator indicating the selected one of the assets.

19. The method of claim 15, wherein the digital assets are digital assets associated with an animated film and the first set of the digital assets comprises one of sequences for the digital movie, shots for one or more of the sequences, rendered images for one or more of the shots, composite layers for one or more of the rendered images, and versions of one or more of the composite layers and the second set of the digital assets comprises a differing one of the sequences for the digital movie, the shots for one or more of the sequences, the rendered images for one or more of the shots, the composite layers for one or more of the rendered images, and the versions of one or more of the composite layers.

20. The method of claim 15, wherein the second user input comprises a search term and the expansion comprises providing for the selected one of the assets ones of the digital assets having a parameter in associated metadata matching the search term and including the matching ones in the second set of the digital assets.
